(19) United States
(12) Patent Application Publication
(10) Pub. No.: US 2008/0044120 A1
(43) Pub. Date: Feb. 21, 2008

(54) Bearing Sealing Device and Rolling Bearing with Cold-Resistant Sealing Devices

(76) Inventor: Kazuo Komori, Iwata (JP)

Correspondence Address: WENDEROTH, LIND & PONACK, L.L.P., 2033 K STREET N. W., SUITE 800, WASHINGTON, DC, 20006-1021, US

(21) Appl. No.: 11/794,254

(22) PCT Filed: Jan. 19, 2006
(86) PCT No.: PCT/JP06/00700

§ 371 Date: Jun. 27, 2007

(30) Foreign Application Priority Data
Jan. 20, 2005 (JP) 2005-012528

(51) Int. Cl. F16C 33/78

(52) U.S. Cl. 384/477

(57) ABSTRACT

For sealing devices for vehicle hub bearings formed with a plurality of seal lips, a rolling bearing is provided having cold-resistant sealing devices which exhibit sealability that is especially superior in cold resistance, which is high in followability of the seal lips even if the bearing is rotated for a long period of time at low temperature, and which can prevent entry of foreign matter such as water into the bearing and leakage of grease.

In a rubber sealing device A or B retained by one of inner and outer rings 1 and 2 or a stiffener 5 and a sleeve 6 of a rolling bearing, which rotate relative to each other, with its seal lips in sliding contact with the other, a sealing device for a bearing is provided which is made of a rubber material of which the temperature at which the rubber material shows a low-temperature elastic recovery of 10% as specified in a cold-resistant TR test (TR10) is not more than −35° C. Thus, even if the bearing is rotated for a long period of time at low temperature, it is possible to prevent entry of foreign matter such as water into the bearing and leakage of grease. By mounting such sealing devices on e.g. a rolling bearing for a vehicle hub, there is provided a rolling bearing for a hub with cold-resistant sealing devices.

### TECHNICAL FIELD

This invention relates to cold-resistant seals suitable for use e.g. in vehicle hub bearings, and more specifically to a bearing sealing device and a rolling bearing having cold-resistant sealing devices.

### BACKGROUND ART

A vehicle hub is a functionally important component part that connects an axle to a rotating wheel. It comprises an inner bearing and oil seals mounted on the hub body from its back, and an outer bearing and a plate washer mounted on the hub body from its front side.

Into such a vehicle hub bearing, foreign matter such as muddy water tends enter while the vehicle is traveling. Such foreign matter may deteriorate grease sealed therein or cause rusting inside the bearing. Thus, such a bearing has rubber seals (also known as sealing devices)(Patent document 1).

Generally, rubber used for bearing seals is one that is highly elastic and high in sealability. But in a low-temperature use state such as outdoors in winter, rubber gradually hardens, so that its followability to the contact surface tends to weaken. This reduces sealability and causes entry of foreign matter and leakage of grease.

In order to improve the cold resistance of such rubber, when considering the mechanism of hardening at low temperature, simple hardening due to a temperature drop in the same phase, hardening and embrittlement due to a temperature change that passes the glass transition point (Tg), and hardening due to crystallization of rubber that tends to crystallize are anticipated.

The cold resistance of rubber cannot be measured only with the glass transition temperature (Tg), but is largely influenced by free mobility of rubber molecules. Thus, if the cohesive force between molecules is strong (i.e. if the polarity is large), mobility of rubber molecules falls, so that flexibility is impaired. Even among hydrocarbon rubbers containing nitrile groups such as acrylonitrile butadiene rubber (NBR), the higher the content of acrylonitrile, the inferior the cold resistance is.

As NBR seals used for seals for shock absorbers in automobiles and motorcycles, for which cold resistance and lubricity are required, a rubber composition is known which comprises NBR and tetrafluoroethylene resin (PTFE) powder (Patent document 2).
Patent document 1: JP patent publication 2003-262231A
Patent document 2: JP patent publication 2000-017110A

### DISCLOSURE OF THE INVENTION

Object of the Invention

But in such conventional rubbers for cold-resistant seals, the physical properties of the rubber compositions are not improved to improve their sealability. In these conventional seals, only means of subjecting the surface of the element called a slinger with which the seal is brought into contact to hardening treatment, or forming thereon a corrosion-resistant and rust-preventive film was used to more reliably improve sealability.

When such cold-resistant seals are actually used, the possibility increases that problems such as failure due to entry of muddy water into the bearing or leakage of grease may arise in cold regions and/or in winter.

If the rubber seal member is too high or too low in hardness while in use, it cannot sufficiently perform its sealing function. Because it was not sufficiently known how the predetermined physical properties of the rubber material and the sealability at a predetermined temperature are related to each other, sealing devices for vehicle hub bearings or the like formed with a plurality of sealing lips were unable to reliably perform its sealing function that is especially superior in cold resistance.

An object of the present invention according to the bearing sealing device of the present application is therefore to solve these problems, and to provide a sealing device for vehicle hub bearings or the like formed with a plurality of sealing lips which reliably performs its sealing function especially superior in cold resistance.

An object of the present invention according to the rolling bearing with cold-resistant sealing devices of the present application is to provide a rolling bearing having cold-resistant sealing devices of which the followability of seal lips is good even when the bearing is rotated for a long time at low temperature, and which is durable with no entry of foreign matter such as water into the bearing and no leakage of lubricant such as grease, and especially a rolling bearing having cold-resistant sealing devices for vehicle hubs.

Means to Achieve the Object

In order to achieve the above object, this invention provides a rubber sealing device for a rolling bearing retained by one of an inner ring and an outer ring of a rolling bearing, or their attachments that rotate relative to each other, and having a seal lip thereof in sliding contact with the other of the inner and outer rings or their attachments to seal the interior of the bearing, characterized in that the sealing device is made of a rubber material of which the temperature at which the rubber material shows a low-temperature elastic recovery of 10% as specified in a cold-resistant TR test (TR10) is not more than −35° C.

With the bearing sealing device according to the invention, because the ring-shaped rubber sealing device with seal lips is made of a rubber material of which the temperature at which the rubber material shows a low-temperature elastic recovery of 10% as specified in a cold-resistant TR test (TR10) is not more than −35° C., as will be also apparent from the later described experiment results, even at outdoor temperatures of 0 to −25° C., which are temperatures expected in Japan, during use of the bearing at which cold resistance is required, the interior of the rolling bearing can be reliably sealed.

That is, because the rubber material of which the temperature at which the rubber material shows a low-temperature elastic recovery of 10% is within the above-described predetermined range reliably performs its sealing function, it will not become too hard or too soft when used in a cold environment, so that it can reliably seal the interior of the rolling bearing while being retained by one of two parts that rotate relative to each other and its seal lips in sliding contact with the other of the two parts.

Such a cold-resistant rubber material is preferably a hydrocarbon rubber containing nitrile groups of which the nitrile content is less than 25%.

The hydrocarbon rubber containing nitrile groups is preferably an acrylonitrile-butadiene copolymer rubber because such a material is readily available.

Preferably, the cold-resistant sealing device for a bearing is preferably mounted on the rolling bearing while being retained by one of the inner and outer rings of the bearing or their attachments (such as sleeves or stiffeners) with its seal lips in sliding contact with the other. Using such cold-resistant sealing devices, it is possible to manufacture a rolling bearing having cold-resistant sealing devices, and especially a rolling bearing for a vehicle hub having cold-resistant sealing devices.

With the rolling bearing with cold-resistant sealing devices, the sealing devices made of a rubber material having a predetermined temperature specified by the low-temperature elasticity recovery 10% (TR10) perform their sealing function superior in cold resistance due to their plurality of seal lips. Thus, especially when they are used for sealing devices for vehicle hub bearings, even if the bearing is rotated for a long period of time at a low temperature of 0° C. or less, or −20° to −25°, followability of the seal lips is good, so that the bearing is durable with no entry of foreign matter such as water into the bearing and no leakage of grease.

### EFFECT OF THE INVENTION

Because the invention according to the bearing sealing device of the present application is made of a rubber material having a low-temperature elastic recovery (TR10) of not more than −35° C., it reliably performs its function of sealing a rolling bearing in a cold environment.

In the invention according to the rolling bearing with cold-resistant sealing devices of the present application, sealing devices for a bearing made of a rubber material having a low-temperature elastic recovery (TR10) of not more than −35° C. are mounted on a rolling bearing while being retained by one of inner and outer rings, or the like, of the rolling bearing with their seal lips in sliding contact with the other, so that the bearing is durable with no entry of foreign matter such as water into the bearing and no leakage of grease.

### BRIEF DESCRIPTION OF THE DRAWINGS

FIG. 1 is a sectional view of a rolling bearing using sealing devices of first and second embodiments.

FIG. 2 is a sectional view of a rolling bearing for a hub using sealing devices of first and third embodiments.

FIG. 3 is a partial sectional view of a rolling bearing of the sealing device of the first embodiment;

FIG. 4 is a partial sectional view of a rolling bearing of the sealing device of the third embodiment;

FIG. 5 is a partial sectional view of a rolling bearing of the sealing device of the second embodiment;

### BRIEF DESCRIPTION OF THE REFERENCES

1, 1′ Inner ring
2, 2′ Outer ring
3 Ball
4 Retainer
5, 10, 13 Stiffener
6 Sleeve
7, 15 Side lip
8, 12, 16 Dust lip
9, 11, 17 Grease lip
14 Hub
A Sealing device of the first embodiment
B Sealing device of the second embodiment
C Sealing device of the third embodiment

### BEST MODE FOR EMBODYING THE INVENTION

The rubber material used for a ring-shaped rubber sealing device having seal lips is not particularly limited in type, and it is possible to use any known rubber having a low-temperature elastic recovery as prescribed in a cold resistant TR test (ASTM D1329) of not more than −35° C.

That is, the cohesive force between rubber molecules is weakened and rubber molecules that are low in polarity are used to improve the mobility of the rubber molecules and maintain flexibility. For example, because the content of nitrile groups, which are polar molecules, is preferably as low as possible within such a range that the required rubber strength is not lost, it is preferable to employ a hydrocarbon rubber containing nitrile groups by less than 25%.

In a TR test (ASTM D1329), stretched test pieces are frozen and the temperature when the recovery rate of the length of each test piece reaches 10% by continuously raising the temperature is used as TR10.

Specific rubbers having a TR10 value of not more than −35° C. include acrylonitrile-butadiene copolymer rubbers (NBR) of which the nitrile content is less than 25%, and silicone rubbers. Commercially available such rubbers include NBR made by Japan Synthetic Rubber Co., Ltd. (JSR250S: low nitrile type, nitrile content: less than 25%)

The following substances may be added to the rubber material within such a range that its durability and the desired effects of the invention are not impaired.

Such substances include reinforcing agents or fillers such as carbon black, silica, clay, calcium carbonate, magnesium hydroxide, aluminum hydroxide, aluminum oxide, talc, mica, kaolin, bentonite, shirasu, wollastonite, silicon carbide, glass powder, carbon powder, boron fiber and aramid fiber, vulcanization assistants such as zinc white and fatty acids, vulcanizing agents or vulcanization accelerators such as guanidines, sulfurs, aldehyde-amines and zinc salts, plasticizers such as dimethylphthalate and dioctylphthalate, anti-aging agents such as amines and phenols, antioxidants, ultraviolet absorbers, flame retardants and colorants.

The method of kneading the abovementioned various materials are not particularly limited. Rather, it is possible to use one of the well-known methods. For example, The synthetic rubber or elastomer as a major component and other fillers may be kneaded successively or simultaneously in a roll mixer, propeller mixer, kneader mixer, Banbury mixer, twin-screw melt mixer, or any other mixer. The mixer is preferably provided with a temperature adjustor to control heat buildup due to friction.

The rubber material composition thus obtained can be formed into a sealing device (seal) having e.g. the shape of a ring by vulcanization or forming by pressing.

Now description is made of how sealing devices embodying this invention are used with reference to the accompanying drawings.

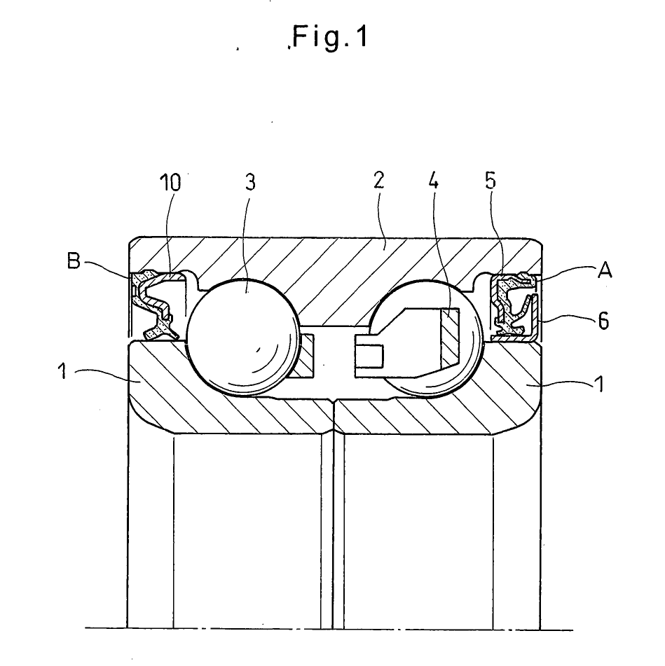

As shown in FIG. 1, sealing devices of first and second embodiments (hereinafter referred to as seals A and B) for a bearing are disposed between inner and outer rings 1 and 2 of a rolling bearing, and held in position by being fixed to the outer ring 2 with their plurality of seal lips in sliding contact with e.g. the inner ring 1. In FIG. 1, numeral 3 indicates a ball, and 4 is a retainer.

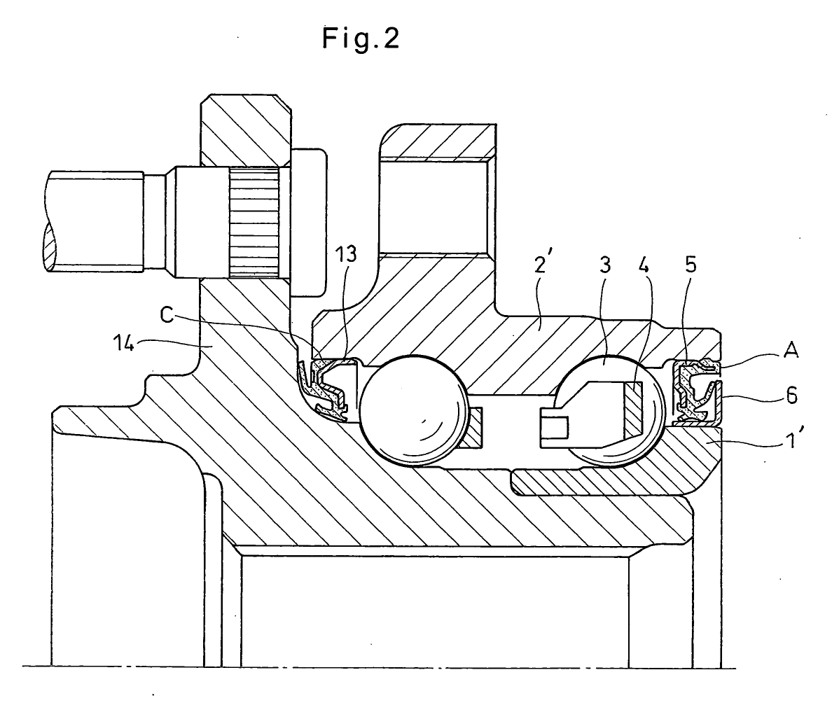

As shown in FIG. 2, the sealing device of the first embodiment (seal A) and a sealing device for a bearing of a third embodiment (hereinafter referred to as a seal C) are disposed between inner and outer rings 1′ and 2′ of a rolling bearing for a hub, and held in position by being fixed to the outer ring 2′ with their plurality of seal lips in sliding contact with e.g. the inner ring 1′. In FIG. 2, numeral 3 indicates a ball, and 4 is a retainer.

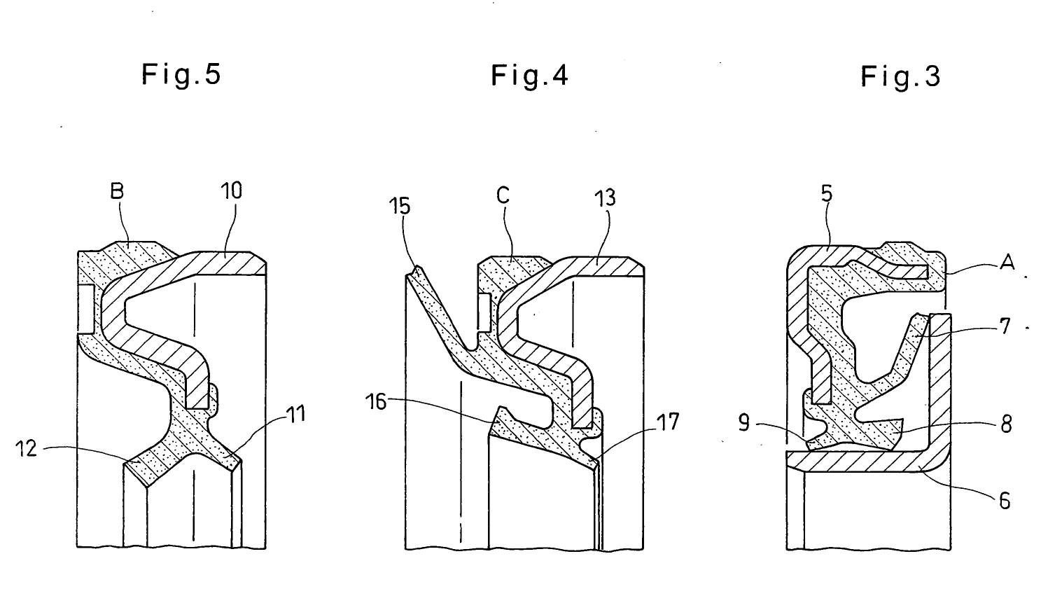

FIG. 3 is an enlarged view of the sealing device for a bearing of the first embodiment (which is the back seal type). It includes a ring-shaped stiffener 5 fixed to the inner surface of the outer ring and having a substantially L-shaped section, and a ring-shaped seal A made of a predetermined rubber material and fixed to the stiffener 5 by covering the edge of the stiffener 5 and being in close contact with the entire inner surface of the stiffener.

The seal A has three lips comprising a side lip 7, a dust lip 8 and a grease lip 9 that are in sliding contact with a sleeve 6 fixed to the inner ring.

As shown in FIGS. 1 and 5, the sealing device for a bearing of the second embodiment (two-lip seal type) has its seal B fixed in position by covering and engaging the edge of a stiffener 10 in the same manner as in the first embodiment.

The seal B has two lips which are different from those of the first embodiment and comprises a grease lip 11 and a dust lip 12 that are directly in sliding contact with the inner ring 1.

As shown in FIGS. 2 and 4, the sealing device for a bearing of the third embodiment (three-lip seal type) has its seal C fixed in position by covering and engaging the edge of a stiffener 13 and being in close contact with the entire inner surface of the stiffener 13.

The seal C has three lips which are different from those of the second embodiment and comprises a side lip 15, a dust lip 16 and a grease lip 17 that are directly in sliding contact with the inner ring 1 or a hub 14.

Now the rolling bearings on which the above-described cold-resistant sealing devices are mounted are described with reference to FIGS. 1 and 2.

The rolling bearing shown in FIG. 1 has the seal A of the first embodiment and the seal B of the second embodiment to seal the gap between the inner ring 1 and the outer ring 2, and is a general-purpose rolling bearing in which a lubricant such as grease is sealed.

The rolling bearing shown in FIG. 2 is mounted particularly on a vehicle drive shaft, and includes the seal A of the first embodiment and the seal C of the third embodiment to seal the interior of the bearing.

With the rolling bearings having the above-described sealing devices, the sealing devices, which comprise a rubber material specified by a predetermined low-temperature elastic recovery 10% (TR10), reliably exhibits sealing functions superior in cold resistance due to their plurality of seal lips.

Particularly when such sealing devices are used for a bearing for a vehicle hub, even if it is rotated at a low temperature of not more than 0° C., particularly −20 to −25° C. for a long time, due to good followability of the seal lips, it is possible to prevent entry of foreign matter such as water into the bearing and leakage of grease, so that the durability of the bearing improves.

### EXAMPLES

### Example 1

NBR was wrapped around a roll mixer with the roll, distance adjusted to about 5 to 10 mm, and inorganic fillers, anti-aging agents, carbon, sulfur and vulcanization accelerators were added one after another at the rates shown in Table 1. Then, these substances were kneaded together. The roll distance was then adjusted to about 1 mm and the mixture was passed between the rolls. At this time, to prevent frictional heat, cooling water was passed through the rolls at all times, thereby keeping the roll temperature at 60° C. or less. A compound was thus obtained.

This compound was subjected to primary vulcanization by pressing in a mold for molding a ring-shaped seal (170° C., 10 minutes, pressing at 30 kgf/cm²) to obtain seals of the first embodiment shown in FIG. 3 (TR10=−41° C.).

The seals obtained were subjected to a cold sealability test under the following conditions. The test results are shown in Table 2.

[Low Temperature Sealability Test]

Only the seals were mounted between parts corresponding to inner and outer rings, and the bearing was immersed in salt water of 20% by weight concentration which was cooled to −20° C. to its axis. In this state, cycles of rotation and stopping of the bearing within a prescribed time period were carried out, and the number of cycles were measured until salt water enters the bearing as the evaluation of sealability.

### Example 2

Seals of TR10=−35° C. (seals of the first embodiment shown in FIG. 3) were formed by adjusting the components of the compound of Example 1 but otherwise in the same manner as in Example 1, and were mounted on the rolling bearing for a hub shown in FIG. 2.

This rolling bearing with the seals was subjected to a cold resistant sealability test under the same conditions as above. The test results are shown in Table 2.

### Comparative Example 1

Seals of TR10=−26° C. (seals of the first embodiment shown in FIG. 3) were formed by adjusting the components of the compound of Example 1, but otherwise in the same manner as in Example 1, and were mounted on the rolling bearing for a hub shown in FIG. 2.

This rolling bearing with the seals was subjected to a cold resistant sealability test under the same conditions as above. The test results are shown in Table 2.

TABLE 1

| | | Content |
|---|---|---|
| Raw material | Trade names or the like | (parts by weight) |
| NBR (Low nitrile | JSR250S made by Japan | 100 |
| type, nitrile | Synthetic Rubber Co. Ltd. | |
| content: less | | |
| than 25%) | | |
| Sodium stearate | General industrial material | 1 |
| Carbon | HAF | 30 |
| Vulcanization | TT made by Ouchi Shinko | 2 |
| accelerator (1) | Chemical Industrial Co., Ltd. | |
| Vulcanization | M made by Ouchi Shinko | 2 |
| accelerator (2) | Chemical Industrial Co., Ltd. | |
| Plasticizer | DOP | 10 |
| Zinc oxide | General industrial material | 10 |
| Sulfur | General industrial material | 1.5 |
| Anti-aging agent | General industrial material | 1.5 |

TABLE 2

| | | Low-temperature |
|---|---|---|
| | TR10 of seal | sealability test |
| Example 1 | −41(° C.) | 160 cycles |
| Example 2 | −35(° C.) | 220 cycles |
| Comparative Example 1 | −26(° C.) | 25 cycles |

As is apparent from the results of Table 2, because the bearing sealing devices of Examples 1 and 2 are made of rubber materials having a low-temperature elastic recovery (TR10) of not more than −35° C., they reliably exhibit rolling bearing sealing functions superior in cold resistance.

When rubber seals having a TR10 value higher than −35° C. are considered, judging from the fact that the number of cycles extremely decreased at the TR10 of −26° C., it is apparent that the low-temperature sealability decreases sharply between TR10 values of −26° C. and −35° C. As the upper limit of such a boundary of the TR10 value, it is possible to employ TR10=−35° C.

1. A rubber sealing device for a rolling bearing retained by one of an inner ring and an outer ring of a rolling bearing, or their attachments that rotate relative to each other, and having a seal lip thereof in sliding contact with the other of the inner and outer rings or their attachments to seal the interior of the bearing, characterized in that the sealing device is made of a rubber material of which the temperature at which the rubber material shows a low-temperature elastic recovery of 10% as specified in a cold-resistant TR test (TRIO) is not more than −35 ° C.

2. The sealing device for a bearing of claim 1 wherein said rubber material is a hydrocarbon rubber containing nitrile groups of which the nitrile content is less than 25%.

3. The sealing device for a bearing of claim 2 wherein the hydrocarbon rubber containing nitrile groups is an acrylonitrile-butadiene copolymer rubber.

4. A rolling bearing having cold-resistant sealing devices wherein the sealing device for a bearing of claim 1 is mounted on said rolling bearing.

5. A rolling bearing having cold-resistant sealing devices wherein the sealing device for a bearing of claim 1 is mounted on a rolling bearing for a vehicle hub.

6. A rolling bearing having cold-resistant sealing devices wherein the sealing device for a bearing of claim 2 is mounted on said rolling bearing.

7. A rolling bearing having cold-resistant sealing devices wherein the sealing device for a bearing of claim 3 is mounted on said rolling bearing.

8. A rolling bearing having cold-resistant sealing devices wherein the sealing device for a bearing of claim 2 is mounted on a rolling bearing for a vehicle hub.

9. A rolling bearing having cold-resistant sealing devices wherein the sealing device for a bearing of claim 3 is mounted on a rolling bearing for a vehicle hub.
